(19) United States
(12) Patent Application Publication
(10) Pub. No.: US 2015/0208179 A1
(43) Pub. Date: Jul. 23, 2015

(54) LASER WELDED SPEAKER AND VIBRATION PLATE THEREOF

(71) Applicant: MERRY ELECTRONICS (SUZHOU) CO., LTD.,, Jiangsu Province (CN)

(72) Inventors: Jui-Cheng Chang, Taichung (TW); Li-Hsin Wu, Taichung (TW)

(21) Appl. No.: 14/641,458

(22) Filed: Mar. 9, 2015

Related U.S. Application Data
(63) Continuation-in-part of application No. 13/856,257, filed on Apr. 3, 2013, now abandoned.

(51) Int. Cl. H04R 23/00; H04R 3/00

(52) U.S. Cl. CPC H04R 23/00; H04R 3/00

(57) ABSTRACT

A laser welded speaker, comprising a magnet, a voice coil disposed around the magnet, a vibration plate fixedly disposed on the voice coil, and a housing for accommodating the magnet, the voice coil and the vibration plate is provided. The vibration plate comprises a vibration plate top arc and a vibration plate edge, the vibration plate top arc is surrounded by the vibration plate edge and is laser welded to the vibration plate edge, one of the vibration plate top arc and the vibration plate edge is made of a first laser-penetrable material, and the other is made of a first laser-absorbable material, wherein the first laser-penetrable material contains a first organic pigment, the first laser-penetrable material containing the first organic pigment is capable of being penetrated by a first infrared laser beam, and wavelength of the first infrared laser beam ranges from 700 nm to 1600 nm.

### CROSS-REFERENCE TO RELATED APPLICATION

This application is a continuation-in-part of a prior U.S. application Ser. No. 13/856,257, filed Apr. 3, 2013. The entirety of each of the above-mentioned patent applications is hereby incorporated by reference herein and made a part of this specification.

### TECHNICAL FIELD

The present invention relates to the field of speakers, and particularly to a laser welded speaker.

### BACKGROUND

In a speaker, a vibration plate is an important component. Quality of the vibration plate has a direct hearing on performance and a service life of the speaker. However, the existing production technology has a certain problem. The vibration plate is generally formed of a vibration plate top arc 8 and a vibration plate edge 9, which are adhered together by using glue 11 (FIG. 4). Generally, the vibration plate top arc 8 and the vibration plate edge 9 having smooth surfaces are fabricated. Since volatilization of solvent in the glue 11 is limited when the glue 11 is coated on the smooth surfaces of the vibration plate top arc 8 and the vibration plate edge 9, the adhesion between the vibration plate top arc 8 and the vibration plate edge 9 provided by the glue 11 is insufficient. Furthermore, since the glue 11 is a macromolecular material and has poor heat-resistant performance, the mechanical strength of the vibration plate including the vibration plate top arc 8, the vibration plate edge 9 and the glue 11 is poor when the temperature rises. Meanwhile, the glue 11 and solvent in the glue 11 are smelly and harm respiratory and nervous systems. In order to prevent pollution, solvent for cleaning the glue 11 needs to be specially reclaimed, thereby increasing the waste processing cost.

At a joint of an upper cover 7 and a lower cover 6 of the speaker, an ultrasonic welding is adopted in the prior art (FIG. 5). However, an energy director 12 is required in the ultrasonic welding. Many kinds of the energy directors such as a step type energy director, a mortise type energy director, a cutting type energy director or a riveting type energy director are adopted in the prior art. Since design of the energy director 12 most depends on factors such as experience of a designer, a thickness of a product, and a shape of the product, quality of the fabricated products (i.e., the speakers) is unstable.

Therefore, a new speaker and a fabricated method thereof are required for resolving the aforesaid disadvantages.

### SUMMARY

The present invention provides a laser welded speaker and a vibration plate thereof.

In an embodiment of the present invention, a laser welded speaker, comprising a magnet, a voice coil disposed around the magnet, a vibration plate fixedly disposed on the voice coil, and a housing for accommodating the magnet, the voice coil and the vibration plate is provided. The vibration plate comprises a vibration plate top arc and a vibration plate edge, the vibration plate top arc is surrounded by the vibration plate edge and is laser welded to the vibration plate edge, one of the vibration plate top arc and the vibration plate edge is made of a first laser-penetrable material, and the other is made of a first laser-absorbable material, wherein the first laser-penetrable material contains a first organic pigment, the first laser-penetrable material containing the first organic pigment is capable of being penetrated by a first infrared laser beam, and wavelength of the first infrared laser beam ranges from 700 nm to 1600 nm.

In another embodiment of the present invention, a vibration plate comprising a vibration plate top arc and a vibration plate edge is provided. The vibration plate top arc is surrounded by the vibration plate edge and is laser welded to the vibration plate edge.

One of the vibration plate top arc and the vibration plate edge is made of a laser-penetrable material, and the other is made of a laser-absorbable material, wherein the laser-penetrable material contains an organic pigment, the laser-penetrable material containing the organic pigment is capable of being penetrated by an infrared laser beam, and wavelength of the infrared laser beam ranges from 700 nm to 1600 nm.

In the present invention, the laser welded speaker and the vibration plate have enhanced heat-resistant performance and the fabrication method thereof is environmental friendly. Furthermore, the quality and the yield rate of the fabricated products (i.e., laser welded speaker and the vibration plate) are enhanced.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of the present invention;

FIG. 2 is a schematic enlarged view A of the present invention;

FIG. 3 is a schematic enlarged view B of the present invention;

FIG. 4 is a schematic enlarged view of an existing vibration plate; and

FIG. 5 is a schematic enlarged view of welding of existing upper and lower covers.

### DETAILED DESCRIPTION OF DISCLOSED EMBODIMENTS

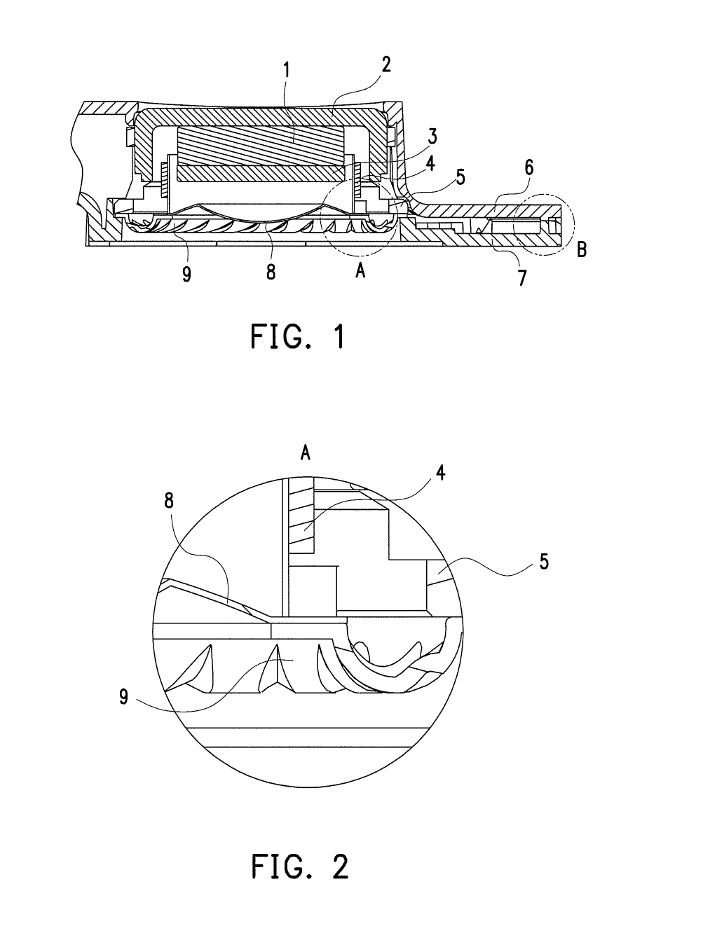

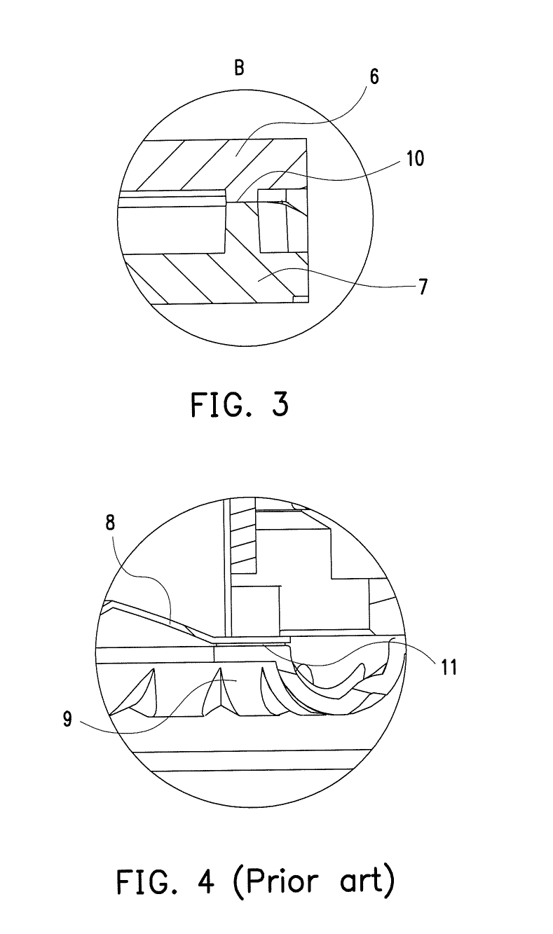

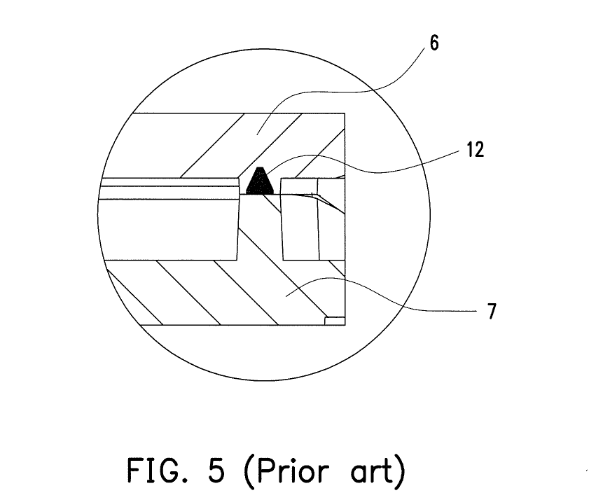

FIG. 1 is a schematic view of the present invention; FIG. 2 is a schematic enlarged view A of the present invention; and FIG. 3 is a schematic enlarged view B of the present invention.

Referring to FIG. 1 through FIG. 3, a laser welded speaker including a magnet 1, a voice coil 4 disposed around the magnet 1, a vibration plate fixedly disposed on the voice coil 4, and a housing for accommodating the magnet 1, the voice coil 4 and the vibration plate is provided. The vibration plate comprises a vibration plate top arc 8 and a vibration plate edge 9, the vibration plate top arc 8 is surrounded by the vibration plate edge 9, and the vibration plate top arc 8 is laser welded to the vibration plate edge 9. For example, the welding interface of the vibration plate top arc 8 and the vibration plate edge 9 is a plane. One of the vibration plate top arc 8 and the vibration plate edge 9 is made of a first laser-penetrable material, and the other is made of a first laser-absorbable material, wherein the first laser-penetrable material contains a first organic pigment, the first laser-penetrable material containing the first organic pigment is capable of being penetrated by a first infrared laser beam, and wavelength of the first infrared laser beam ranges from 700 nm to 1600 nm. Preferably, wavelength of the first infrared laser beam ranges from 920 nm to 1064 nm.

In an embodiment of the present invention, the vibration plate top arc 8 is made of a first laser-penetrable material, and the vibration plate edge 9 is made of a first laser-absorbable material containing the first organic pigment. The material of the first laser-penetrable material comprises a first laser-absorbable base material, and the first organic pigment is distributed in the first laser-absorbable base material. For example, the first laser-absorbable base material for fabricating the vibration plate top arc 8 is substantially the same with the first laser-absorbable material of the vibration plate edge 9. In this embodiment, the material of the first laser-absorbable base material is, for example, polyvinyl chloride (PVC), polycarbonate (PC), polyethylene terephthalate (PET) or other dielectric material. The material of the first laser-penetrable material is, for example, polyvinyl chloride (PVC), polycarbonate (PC) or polyethylene terephthalate (PET) having organic pigment doped therein. For example, the material of the organic pigment is commercially available FK4280 product or FK4281 product sold by BASF Company. In this embodiment, the first laser-penetrable material, the laser-absorbable material and the laser-absorbable base material are of dark color (e.g., black, dark gray etc.)

In another embodiment of the present invention, the vibration plate edge 9 is made of the aforesaid first laser-penetrable material, and the vibration plate top arc 8 is made of the aforesaid first laser-absorbable material containing the first organic pigment. For example, the first laser-absorbable base material for fabricating the vibration plate edge 9 is substantially the same with the first laser-absorbable material of the vibration plate top arc 8.

When the vibration plate top arc 8 is laser welded to the vibration plate edge 9, bonding strength between the vibration plate top arc 8 and the vibration plate edge 9 is enhanced significantly. Additionally, since the laser-penetrable material contains organic pigment and allows the infrared laser beam passing through, heat generated at the welding interface of the vibration plate top arc 8 and the vibration plate edge 9 is reduced when infrared laser beam is irradiated on the welding interface. In other words, temperature at the welding interface of the vibration plate top arc 8 and the vibration plate edge 9 can be lowered by the organic pigment during laser welding process. Accordingly, possibility of peeling or delamination between the vibration plate top arc 8 and the vibration plate edge 9 is low.

In this embodiment, the aforesaid housing includes a frame 5, a lower cover 6 and an upper cover 7 fitting with the lower cover 6, wherein the lower cover 6 is laser welded to the upper cover 7, and the frame 5 arranged between the lower cover 6 and the upper cover 7, wherein the vibration plate is fixedly arranged in the frame 5. As shown in FIG. 1, the laser welded speaker may further include a pole piece 3 disposed on the magnet 1 and a lower piece 2 for carrying the magnet 1 and the pole piece 3, wherein the magnet 1 is between the pole piece 3 and the lower piece 2. Specifically, the frame 5 is arranged between the lower cover 6 and the upper cover 7, the vibration plate is arranged on the frame 5, the lower piece 2 is arranged at a bottom of the frame 5, the magnet 1 is arranged in the middle of the lower piece 2, and the pole piece 3 is arranged on the magnet 1. In addition, the vibration plate is formed of the vibration plate top arc 8 located in the middle and the vibration plate edge 9 located at a periphery, and a thickness of the vibration plate top arc 8 is less than a thickness of the vibration plate edge 9.

It is noted that the upper cover 7 and the lower cover 6 are fixedly connected together through laser welding, and a welding interface 10 of the upper cover 7 and the lower cover 6 is a plane. In an embodiment of the present invention, the upper cover 7 is made of a second laser-penetrable material, and the lower cover 6 is made of a second laser-absorbable material. The second laser-penetrable material contains a second organic pigment; the second laser-penetrable material containing the second organic pigment is capable of being penetrated by a second infrared laser beam, and wavelength of the second infrared laser beam ranges from 700 nm to 1600 nm. Preferably, wavelength of the first infrared laser beam ranges from 920 nm to 1064 nm. For example, the second laser-penetrable material comprises a second laser-absorbable base material, and the second organic pigment is distributed in the second laser-absorbable base material. Furthermore, the second laser-absorbable base material for fabricating the lower cover 6 is, for example, substantially the same with the second laser-absorbable material of the upper cover 7. In this embodiment, the material of the first laser-absorbable base material is, for example, polyvinyl chloride (PVC), polycarbonate (PC), polyethylene terephthalate (PET) or other dielectric material. The material of the first laser-penetrable material is, for example, polyvinyl chloride (PVC), polycarbonate (PC) or polyethylene terephthalate (PET) having organic pigment doped therein. For example, the material of the organic pigment is commercially available FK4280 product or FK4281 product sold by BASF Company. In this embodiment, the first laser-penetrable material, the laser-absorbable material and the laser-absorbable base material are of dark color (e.g., black, dark gray etc.)

In another embodiment of the present invention, the lower cover 6 is made of the aforesaid second laser-penetrable material, and the upper cover 7 is made of the aforesaid second laser-absorbable material. For example, the second laser-absorbable base material for fabricating the upper cover 7 is substantially the same with the second laser-absorbable material of the lower cover 6.

In the aforesaid embodiments, the vibration plate top arc 8 and the vibration plate edge 9 are welded through laser, thereby improving heat-resistant performance of the vibration plate and reducing harm to a human body and environmental pollution. In another embodiment of the present invention, since the upper cover 7 and the lower cover 6 are welded through laser and the welding interface of the upper and lower covers is a plane, a welding wire is not required and the production cost is reduced and quality is enhanced.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A laser welded speaker, comprising:
a magnet;
a voice coil disposed around the magnet;
a vibration plate fixedly disposed on the voice coil, the vibration plate comprising a vibration plate top arc and a vibration plate edge, the vibration plate top arc being surrounded by the vibration plate edge and being laser welded to the vibration plate edge, one of the vibration plate top arc and the vibration plate edge being made of a first laser-penetrable material, and the other being made of a first laser-absorbable material, wherein the first laser-penetrable material contains a first organic pigment, the first laser-penetrable material containing the first organic pigment is capable of being penetrated by a first infrared laser beam, and wavelength of the first infrared laser beam ranges from 700 nm to 1600 nm; and
a housing for accommodating the magnet, the voice coil and the vibration plate.

2. The laser welded speaker according to claim 1, wherein a welding interface of the vibration plate top arc and the vibration plate edge is a plane.

3. The laser welded speaker according to claim 1, wherein the first laser-penetrable material comprises a first laser-absorbable base material, and the first organic pigment is distributed in the first laser-absorbable base material.

4. The laser welded speaker according to claim 3, wherein the first laser-absorbable base material is the same with the first laser-absorbable material.

5. The laser welded speaker according to claim 1, wherein wavelength of the first infrared laser beam ranges from 920 nm to 1064 nm.

6. The laser welded speaker according to claim 1, wherein the housing comprises:
a lower cover;
an upper cover fitting with the lower cover, wherein the lower cover is laser welded to the upper cover; and
a frame arranged between the lower cover and the upper cover, wherein the vibration plate is fixedly arranged in the frame.

7. The laser welded speaker according to claim 6, wherein a welding interface of the lower cover and the upper cover is a plane.

8. The laser welded speaker according to claim 6, wherein one of the lower cover and the upper cover is made of a second laser-penetrable material, and the other is made of a second laser-absorbable material, the second laser-penetrable material contains a second organic pigment, the second laser-penetrable material containing the second organic pigment is capable of being penetrated by a second infrared laser beam, and wavelength of the second infrared laser beam ranges from 700 nm to 1600 nm.

9. The laser welded speaker according to claim 8, wherein the second laser-penetrable material comprises a second laser-absorbable base material, and the second organic pigment is distributed in the second laser-absorbable base material.

10. The laser welded speaker according to claim 9, wherein the second laser-absorbable base material is the same with the second laser-absorbable material.

11. The laser welded speaker according to claim 8, wherein wavelength of the second infrared laser beam ranges from 920 nm to 1064 nm.

12. The laser welded speaker according to claim 6 further comprising:
a pole piece disposed on the magnet; and
a lower piece for carrying the magnet and the pole piece, wherein the magnet is between the pole piece and the lower piece.

13. A vibration plate, comprises:
a vibration plate top arc; and
a vibration plate edge, the vibration plate top arc being surrounded by the vibration plate edge and being laser welded to the vibration plate edge, one of the vibration plate top arc and the vibration plate edge being made of a laser-penetrable material, and the other being made of a laser-absorbable material, wherein the laser-penetrable material contains an organic pigment, the laser-penetrable material containing the organic pigment is capable of being penetrated by an infrared laser beam, and wavelength of the infrared laser beam ranges from 700 nm to 1600 nm.

14. The vibration plate according to claim 13, wherein a welding interface of the vibration plate top arc and the vibration plate edge is a plane.

15. The vibration plate according to claim 13, wherein the laser-penetrable material comprises a laser-absorbable base material, and the organic pigment is distributed in the laser-absorbable base material.

16. The vibration plate according to claim 15, wherein the laser-absorbable base material is the same with the laser-absorbable material.

17. The vibration plate according to claim 13, wherein wavelength of the infrared laser beam ranges from 920 nm to 1064 nm.
